(19) United States
(12) Patent Application Publication
(10) Pub. No.: US 2012/0105839 A1
(43) Pub. Date: May 3, 2012

(54) Progressive Cut-Size Particle Trap and Aerosol Collection Apparatus

(75) Inventors: Igor V. Novosselov, Seattle, WA (US); Peter C. Ariessohn, Lake Tapps, WA (US)

(73) Assignee: ENERTECHNIX, INC, Maple Valley, WA (US)

(21) Appl. No.: 12/833,665

(22) Filed: Jul. 9, 2010

Related U.S. Application Data
(60) Provisional application No. 61/224,861, filed on Jul. 11, 2009.

(51) Int. Cl. G01J 3/44; G01N 21/55

(52) U.S. Cl. 356/301; 73/863.22; 356/445

(57) ABSTRACT

Improved centrifugal particle traps for aerosol particle collection and sampling characterized by a curved, progressively tapered impactor channel operable over a incompressible or compressible flow regime, or a flow regime transitioning from incompressible to compressible over the length of the particle trap. Mixtures of particles in a flowing gas stream are impactingly captured and separated by size. The particle traps can be operated to collect submicron particles without blockage, have lower pressure drops to reduce overall power requirements, and surprisingly, viability of biological particles captured in the particle traps of the invention is increased. Also disclosed are systems and methods combining these improved particle traps with in-line particle concentrators and with aerosol sample or liquid sample processing and analysis systems.

### RELATED APPLICATIONS

This application is a Non-Provisional Application and claims the benefit under 35 U.S.C. §119(e) from U.S. Provisional Patent Application No. 61/224,861 filed Jul. 11, 2009; said priority document being incorporated herein in entirety by reference.

### FIELD OF INVENTION

This invention relates to methods and devices for measuring and sampling particulate matter in a gas.

### BACKGROUND

The technology for aerosol monitoring continues to evolve. Demand has been driven primarily in the security, military, and biomedical fields, but also is expanding for industrial and environmental applications.

One class of aerosol collectors includes centrifugal impactors. These collectors rely on single pass inertial impaction to separate particles from a flowing gas stream, and are thus gas-to-solid collectors, but have not been widely used because conventional designs suitable for collection of particle size ranges most frequently of interest are subject to rapid fouling in use and require frequent service or replacement. If the fouling problem can be solved, this class of impactors may be superior to related technologies in collection of smaller particles (0.2 to 2.0 microns Dₐ), which are frequently of special interest as biohazards because of their ability to penetrate the respiratory tract. More commonly deployed are filter cartridges, multistage inertial impactors, or gas-to-liquid collectors. These include the Andersen cascade plate impactors, wetted wall cyclones, wetted rotating vane impactors, and liquid impingers, which are relatively inefficient in single pass mode, particularly for capturing particles with aerodynamic diameters (Dₐ) in the range of 0.2 to 2.0 microns. Wetted wall impactors and liquid impingers require relatively large volumes of liquid to operate, typically tens of milliliters or more, and are not well adapted for collecting viable biological particles.

Illustrative for example of the art is U.S. Pat. No. 3,983,743 to Olin and Marple, which describes a multi-stage cascading plate impactor where the cut-size for each plate in the descending stack is smaller so that larger particles are collected on the upper plates and smaller particles on the lower plates. These collectors, however, continue to be plagued by inter-stage losses and have not been satisfactory in particle size-fractionation due to particle “re-entrainment” following “bouncing” collisions from wall surfaces. The collectors are also ineffective in trapping sub-micron particles and typically rely on a terminal filter membrane or the smaller particles “are ignored altogether,” according to Olin.

In U.S. Pat. No. 4,133,202, again describing a plate impactor, Marple uses a single coverplate and underlying plate impactor with multiple inlet nozzles or slits in the coverplate to collect particles of different particle sizes, each nozzle or slit having a different cut-size. Gas flows in parallel through the various nozzles and particles are impactingly captured under each nozzle according to the flow split. However, the absolute efficiency in collecting smaller and sub-micron particles continues to be low because the pressure drop through the nozzles is constant and independent of nozzle size. A lower limit of collection efficiency is typically about 2 microns Dₐ.

In U.S. Pat. No. 5,437,198, John describes a plate impactor with slit nozzle intake which tapers in width along its long axis. An impaction plate is seated below the intake and impactingly captures oversize material. The impaction plate is sloped so that the impaction surface is at a greater distance below the wide parts of the slit and at a lesser distance below the narrow parts of the slit. The device is designed so that materials greater than 10 microns are efficiently removed on the impaction plate and smaller particles escape and are captured with relatively higher efficiency on a filter disk covering the exhaust. The invention thus has all the inherent disadvantages of filter membranes, which include degradation on wetting, distribution of the sample over a large surface area, non-selectivity in particle capture, and difficulty in recovering sample from the filter.

Centrifugal particle traps also have limitations, which are: a) a limited capacity to collect smaller particles in the presence of larger particles due to rapid blockage of the trap, b) difficulty in collecting sub-micron and micron-sized particles due to the velocities and pressure drops required, and c) difficulties in collecting viable biological particles due to shear forces and desiccation. Thus there is an interest in improving centrifugal particle trap technology to overcome these limitations. This invention addresses these difficulties and makes improvements in centrifugal particle trap design that will be apparent by consideration of the disclosure herein, which includes the written description, the drawings and the claims.

### SUMMARY

This invention relates to centrifugal particle traps having a continuously graduated cut-size, also termed “progressive cut-size centrifugal impactors”, which rely on tangential inertial impaction to capture a particle from a gas stream on an impactor surface in a collector channel. The centrifugal impactors of the invention work by deflecting the gas stream through a concavoconvexedly curved subsection of a collector channel under conditions favoring laminar flow with boundary layer, the collector channel having a tapering, graduated critical dimension that establishes the nature of the local flow regime at a given overall flow rate. The curved tapered geometry is advantageous because higher terminal velocities can be achieved at lower pressure drops. Particles impact on the concave inside wall of the collector channel if the particle's trajectory crosses all the bending gas streamlines in the curved subsection of the trap. Particles are impacted at a downstream distance in the curved subsection as determined by a complex function of their mass, diameter, velocity, and the viscous drag acting on them.

The particle trap impactors of the present invention operate by ducting the gas and particle stream through a progressively narrowed curved channel, can be scaled for lower Reynold's numbers (hence having lower power consumption), and can be operated under laminar flow conditions, unlike cyclonic collectors. The laminar flow boundary layer has the effect of reducing the intensity of particle collisions with the wall during inelastic capture and thereby reducing particle re-entrainment or “bounce” so as to improve the capture efficiency with less energy expended. By use of tight bending radii, smaller particles can be effectively captured at much lower pressure drops across the collector, increasing resistance to blockage.

The particle traps of the invention are characterized in that the concavoconvexedly curved subsection of the collector channel is turned and tapered simultaneously, the tapering resulting in a progressively diminishing critical dimension L_{c} as the channel bends and narrows from upstream end to downstream end. Inventively, with this geometry, both compressible and incompressible flow regimes can be achieved, and the thickness of the boundary layer can be tailored to blanket particles according to their size. The invention addresses the problem of collecting and sampling aerosol particles in a particle trap while overcoming one or more difficulties of prior art inertial impactors based on “U-tube” geometry, which include: a) a limited capacity to collect smaller particles in the presence of larger particles due to rapid blockage of the trap, b) a limited capacity to collect particles in the range of 0.2 to 2 microns Dₐ due to operational impracticalities in the flow velocities and pressure drops required, and c) difficulties in collecting viable biological particles due to shear forces and desiccation. Bacterial cells impacted in prior art devices, for example, have been observed to die due to impact stresses, shear forces and subsequent desiccation, factors that disrupt cell structure and integrity.

The collector channel is joined to an intake arm for receiving a gas stream and an outlet arm for applying a suction pressure that accelerates the gas stream. The gas stream is typically supplied as a particle-rich jet by an upstream aerosol concentrator, aerodynamic lens or skimmer assembly. In the curved subsection of the particle trap between the inlet arm and the outlet arm, the gas stream velocity is progressively increased as the collector channel is narrowed. By progressively narrowing the critical dimension in a curved section of a particle collection channel, impaction is spread out over an elongated impactor surface area as a function of the inertia of the particle. In what could be termed “centrifugal size chromatography”, impacted particles are spread out and distributed according to their mass along the elongated impactor surface. The sample is thus a “field” of particles ranging from large to small along the concave face of the curved subsection. Larger particles are the first to impact; smaller particles are the last to impact. The device thus has a “progressive cut-size” and separates the particles by apparent aerodynamic diameter over the length of the elongate impactor surface. We term these improved devices “progressive cut-size” particle traps. There are unexpected benefits of the progressively narrowing critical dimension in the curvature of a centrifugal particle trap, particularly in that target aerosols may be denser and may be sampled for longer periods of time without overloading a progressive cut-size collector; the pressure drop through a progressive cut-size collector is not as great as for a constant dimension collector channel having an equivalent cut-size limit, reducing power requirements; at any given point on the elongate impactor surface, the boundary layer is generally thicker or deeper than the aerodynamic diameter of the biological particles of interest, resulting in decreased desiccation and loss of viability; and particles are decelerated as they pass through the boundary layer so that their terminal velocity upon impact with the impactor surface is quite small and delicate bacteria are unlikely to be damaged in the deposition process, also improving resolution of size fractionation by dampening particle “bounce”.

Also, since particles of any particular size range each fall in a different region of the elongate impactor surface, selective inspection of the sample field at a calibrated distance along the elongate impactor surface can be useful in screening for selected classes of particles. Large particles such as road dust need not interfere with the analysis of spores, for example. Particles of a size deemed a critical respiratory hazard may be efficiently collected, particularly those in the 0.2 to 2 micron and 0.5 to 10 micron classifications, and are collected separately from oversize materials such as road dust and fibers. Particle capture in a centrifugal impactor is generally a step in an analytical method, which includes steps for concentration of the particles in the gas stream, collection and separation of the particle mass from the gas stream, and then analysis, which may be immediate or delayed, in situ or remote, and before or after elution of the particles from the particle trap. Analysis may be conducted on the dry aerosol sample directly on the impactor surface or on a liquid sample of solubilized or resuspended material from the trap, as desired by the investigator. Thus the invention is also a method for collection, processing, and analysis of aerosol particles, and an apparatus with optional modular analytical or sample processing capabilities built around the centrifugal particle trap of the invention.

Thus in a first aspect, the invention is an improved centrifugal particle trap having a continuously graduated cut-size, which comprises a collector channel, the collector channel having an intake arm with inlet port for receiving an aerosol particle entrained in a flowing gas stream and an outlet arm for discharging a particle-depleted gas stream, the outlet arm with fluidic connection to a downstream suction pressure source such as a vacuum pump; where the collector channel is characterized by a) a concavoconvexedly curved subsection disposed between the intake arm and the outlet arm of the collector channel, the curved subsection having an upstream end and a downstream end, a convex inside surface, a concave inside surface, a bend, and a taper with a progressively narrowed critical dimension that narrows from upstream end to a neck of least critical dimension proximate to the downstream end; and b) an elongate centrifugal impactor surface formed on the concave inside surface for impactingly capturing an aerosol particle, the elongate centrifugal impactor surface extending from the upstream end through the neck of the collector channel, the captive aerosol particle constituting an “aerosol sample”.

In a related aspect, the elongate centrifugal impactor surface and progressively narrowing critical dimension are configured for varying a flow velocity, a bending curvature, and a thickness of a boundary layer of the flowing gas stream from the upstream end to the downstream end, the boundary layer having a maximum thickness at the upstream end and a minimum thickness at the neck or throat. The geometry results in the capacity of the collector to be configured for operation in an incompressible flow regime, generally defined as having a maximal flow velocity of about 0.3 Mach or less, or in a compressible, subsonic flow regime, generally defined as having a maximal flow velocity between 0.3 Mach and 0.8 or less than 1.0 Mach, and to be operated in a mixed or transitional flow regime having an incompressible flow regime at the upstream end and a compressible flow regime at the neck or throat. The collector channel may also include a terminal diffuser, where the diffuser is fluidly connected to the throat for transonic flow regimes, generally defined as having a maximal flow velocity between 0.8 and 1.0 Mach, or possibly for supersonic flow regimes. By virtue of the progressive taper, the power requirements and pressure drop for achieving these operating conditions are substantially reduced.

In yet another embodiment the inlet port of the collector channel is configured for receiving a minor flow from an aerosol concentrator, where the aerosol concentrator is a virtual impactor, optionally also comprising an aerodynamic lens, an array of aerodynamic lenses, or an intake nozzle for enriching the particle content of the gas stream directed into the collector channel.

In a related embodiment, the invention is an apparatus with centrifugal particle trap of claim 1 and having a detection capability. Detection may be a modular analysis function, mounted on-board or off-board, and is configured for detecting a biological particle or constituent thereof, an aerosol particle or constituent thereof, or an explosives residue or constituent thereof in the aerosol sample.

In yet another embodiment, the centrifugal particle trap of the invention is enclosed in a compact body or block for mass production, with coupling nipples and reversible closures on the receiving arm and on the outlet arm for isolating the aerosol sample in the block during transport and storage.

Alternatively, the collector channel may be configured for receiving a first liquid thereinto, wherein the liquid, when contacted with the elongate impactor surface of the particle trap, is efficacious for suspending or dissolving the aerosol sample as a suspension or a solution, thereby forming a liquid sample. An injection duct joining a liquid reservoir to the collector duct is commonly used for this purpose. The liquid reagent may be a wash reagent, an analytical reagent, or a reactant, for example, the liquid selected for its efficacy in the detection, characterization or quantitation of an aerosol particle or constituent thereof, a biological particle or constituent thereof, or an explosives residue or constituent thereof, such as a nucleic acid assay, an immunoassay, or a spray ionization mass spectrogram of said liquid sample, while not limited thereto. These aspects and others will be described in more depth by reference to the following figures and detailed description.

### BRIEF DESCRIPTION OF THE DRAWINGS

The teachings of the present invention can be readily understood by considering the following detailed description in conjunction with the accompanying drawings, in which:

FIG. 1A is an illustration of a progressively tapered particle trap showing impaction of particles of differing sizes along the slope of the elongate impactor surface. FIGS. 1B and 1C are detailed views of the concavoconvex subsection of the collector duct.

FIG. 2 is a plot demonstrating the relationship of cutoff size and varying critical dimension in centrifugal particle traps under constant flow rate.

FIG. 3 is a schematic of a progressively tapered particle trap having an optional inlet for injecting a fluid.

FIG. 4 is a schematic of a progressively tapered particle trap having an optional branched fluid sub-circuit for sample elution or analysis.

FIG. 5 is a schematic of a progressively tapered particle trap having an optional fluidic inlet and outlet.

FIG. 6 is a block diagram of an apparatus for concentration, collection and analysis of an aerosol particle sample.

FIG. 7 depicts schematically an apparatus for concentration, collection and preservation of an aerosol particle sample with optional chiller unit and transport capability.

FIG. 8 is a schematic of a progressively tapered particle trap integrated in the body of a analytical cartridge with liquid sample handling microcircuitry.

FIG. 9 is a view of a progressively tapered particle trap having compound curvature.

FIGS. 10A and 10B are views of a loop-type progressively tapered particle trap with terminal diffuser stage attached to a throat.

FIGS. 11A and 11B are views of a loop-type progressively tapered particle trap with terminal straight neck.

### DETAILED DESCRIPTION

Although the following detailed description contains selected details and annotations for the purposes of illustration, one of skill in the art will appreciate that variations, substitutions and alterations to the following materials are within the scope of the invention. Accordingly, the exemplary embodiments of the invention described below are set forth without any loss of generality to, and without imposing limitations upon, the claimed invention.

Certain meanings are defined here as intended by the inventors, ie. they are intrinsic meanings Other words and phrases used here take their meaning as consistent with usage as would be apparent to one skilled in the relevant arts. When cited works are incorporated by reference, any meaning or definition of a word in the reference that conflicts with or narrows the meaning as used here shall be considered idiosyncratic to said reference and shall not supersede the meaning of the word as used herein by the inventors.

Definitions

An “aerosol particle”—is a generally diminutive or lightweight body of solid, liquid or gel-like matter suspended or dispersed in a gas volume. This can include, without limitation thereto, dust motes, exfoliated skin cells, fibers, spores, vegetative cells, mists, condensates, virus particles, bacteria, yeasts, mucous droplets, microdroplets of saliva and bronchial secretions, pollen grains, fly ash, smog condensate, smoke, fumes, dirt, fogs (as in industrial or agricultural spray application), salt, silicates, metallic particulate toxins, tar, combustion derived nanoparticles, particulate toxins, and the like. The aerosol particle may be a composite, containing both solid and liquid matter. Such particulate bodies can remain suspended in a column of air for long periods of time, can be carried on currents in the air, or can settle onto surfaces from which they may be resuspended by agitation.

“Aerosol”—refers to a population of small or lightweight bodies termed “aerosol particles” suspended or dispersed in a gas volume. Because an aerosol is composed of both a gas and a suspended or dispersed phase, care is generally taken to refer to “aerosol particles” when the suspended or dispersed material is referred to.

“Apparent Aerodynamic Diameter” (Dₐ)—is defined as the diameter of a sphere of unit density (1 g/cm³) that attains the same terminal settling velocity (vₛ) at a low Reynolds number as the actual particle under consideration. For mathematical modeling purposes, it is convenient to express the behavior of an irregularly shaped particulate specimen as if it were a spherical particle, making it easier to predict, compare and correlate various materials. Typically, the density of a particulate sample is not known during field sampling and calculations are generally performed assuming unit particle density (1 g/cm³).

Critical Dimension—the dimension L_{c} in a channel or tube that is a determinate in establishing flow velocity and flow regime conditions of a gas stream through a channel or tube. The critical dimension determines the local Reynold's number and is used in calculation of the Stokes Number Stk. As defined in the present invention, the critical dimension need not be a constant and may be continuously graduated or “progressive” from the inlet of the progressive centrifugal particle trap to the outlet.

“Cut-size”—is defined as the particle size Dₐ for which 50% of the particles of that size class are captured on a particle trap impactor, generally an inertial impactor, of defined geometry under the specified conditions of operation. As understood in the prior art, the cut-size of an inertial impactor, Dₚ^{I50}, is a constant that characterizes a particular device. For example, the impactor of U.S. Pat. No. 4,133,202 has multiple inlets of differing size, and each inlet has a defined cut-size. However, in the particle traps of the present invention, the cut-size is progressive and not constant from inlet to outlet of the particle trap, and because critical dimension, curvature, flow regime, and gas velocity are not constants, cut-size is dependent at any given cross-section or point in the trap on the critical dimension, curvature, and gas velocity unique to that local area or cross-section. The behavior of the impactor requires consideration of the Stokes number (Stk), which is the ratio of the particle stopping distance at a local gas velocity to the channel critical dimension, and the Reynolds number (Re), since Stk and Re govern particle and gas phase flow behavior in the impactor. The stopping distance is defined as the maximum distance a particle of size Dₐ can travel with an initial velocity in still air without any external forces. By impactor theory, taking

Stk_{Lc}=[ρₚ·Dₚ²·C_{c}·Uₒ]/[18·μ_{f}·L_{c}]

and

Re_{Lc}=[ρ_{f}·Uₒ·L_{c}]/[μ_{f}]

where:
Dₚ=particle diameter
ρₚ=particle density
ρ_{f}=fluid density
C_{c}=slip correction factor
Uₒ=velocity at critical dimension
μ_{f}=fluid kinematic viscosity
L_{c}=critical dimension,

Stk is predictive of collector efficiency as a function of particle size. For a Stk>>1, particles should follow a straight line as the gas turns and for a Stk<<1, particles should follow the gas streamlines.

“Aerosol concentrator module”—includes aerodynamic lens concentrators, aerodynamic lens array concentrators, and micro-aerodynamic lens array concentrators, when used in conjunction with a virtual impactor such as skimmer or other means for splitting a gas flow into a particle-enriched core flow (also termed “minor flow”) and a “bulk flow”, which is generally discarded. Also generally included are cyclone separators, ultrasound concentrators, and air-to-air concentrators for generating a flow split, where the “flow split” refers to the ratio of the minor flow to the bulk flow or total flow. The particle-enriched gas stream is delivered to an outlet of the aerosol concentrator module and may be conveyed to an aerosol collector module. Aerosol pre-concentration prior to sample collection offers a significant advantage when coupled to most analytical methods. Using a variety of devices known in the art as “virtual impactors”, aerosol particles to be sampled from a larger volume of air are concentrated into a particle-enriched gas stream of smaller volume (the “minor flow”) while the bulk of the sampled air, depleted of particles, (also termed “bulk flow” or “major flow”) is exhausted. Such aerosol concentrating devices are described in US Patent Appl. 2008/0022853, entitled “Aerodynamic Lens Particle Separator”, U.S. patent application Ser. No. 12/364,672, “Aerosol Collection and Delivery for Analysis, and U.S. patent application Ser. No. 12/125,459, “Skimmer for Concentrating an Aerosol”, and are co-assigned to the Applicant. Other air-to-air concentrators include virtual impactors such as the US Army's XM2 virtual impactor, those described in U.S. Pat. Nos. 3,901,798, 4,670,135, 4,767,524, 5,425,802, 5,533,406 and 6,698,592, and others.

“Aerodynamic lens” (ADL)—is a device having a passage for a gas stream characterized by constrictions (lenses) that have the effect of focusing the particle content of the gas into a core flow region or “particle beam” surrounded by a sheath of particle depleted air. An ADL can further be configured with a virtual impactor (also termed a “skimmer”) for separating the particle-enriched core flow (also termed “minor flow”) from the sheath flow (commonly termed “bulk flow”) which is generally discarded.

“Skimmer”—a virtual impactor device for separating a bulk flow from a particle-enriched core flow, generally used with an aerodynamic lens or lens array to form a gas-to-gas aerosol concentrator.

“Particle trap”—as used here, refers to a collector channel having the property of reversibly capturing aerosol particles on an impactor surface from a gas stream by virtue of their inertia. Whereas gas streamlines bend to follow curves in the collector channel, particles with sufficient inertia collide with the walls. Particles are captured on a surface or surfaces of the particle trap, termed herein “impactor surface(s)”. The particle traps of the invention are characterized by a “progressive cut-size” and have a curvature and progressively narrowing critical dimension from inlet to outlet.

Inertial Impactor—a body or member having an impactor surface which is disposed in a gas flow such that streamlines of the gas flow are deflected around or over the impactor surface but particles with inertia exceeding the cut-off of the collector collide with the impactor and are preferably captured on it.

“Centrifugal Impactor”—describes a family of inertial impactors for capture of aerosol particles (i.e. aerosol or aerosols) from a streaming laminar flow of a gas, in which a channel for conducting the gas flow is bent or curves, forming a curved channel or passageway for the flowing gas. Where the concavedly curving windward inner wall intersects or impinges on the long axis of gas flow, inertial force will cause more dense aerosol particles to impact what is termed here the “inertial impactor surface” or “elongate centrifugal impactor surface”, the area of the inside wall crossing or impinging on the long axis of flow. In a collector channel, an impactor surface is formed wherever an internal wall of the curving passage intersects or impinges on the long axis of gas flow, deflecting the gas streamlines. The channel geometry for an inertial impactor is generally tubular, having a circular, ovoid, annular, or slit-like generally rectangular cross-section.

“Concavoconvex”—refers to a section of a channel or conduit in which the bending of the channel and curvature of the walls is seen to be concave on one side and convex on the other side of the channel. The curvature need not be symmetrical. The concavoconvexedly bending section has what may be termed a “windward wall”, the inside concave surface of the bend, and a “leeward wall”, the inside convex surface of the bend. The elongate centrifugal impactor surface (5) is formed on the windward wall of the bend and is where centrifugal impaction occurs.

“Upstream” and “downstream” indicate the relative position of components through which a flow is passed. “Upstream” refers to a relative location of a structure or module nearer or in the direction of an inlet of flow; “downstream” refers to a location of a structure or module nearer or in the direction of an outlet of flow.

“Aerosol Collector Module”—refers to an apparatus or subassembly of an apparatus for collecting and impactingly capturing an “aerosol sample” or constituents thereof. Aerosol collector modules may contain inertial impactors, centrifugal impactors, liquid impingers, bluff body impactors, or electrostatic impactors. Fluidic systems are optionally provided for elution of the captured material as a “liquid sample”. The aerosol collector module is thus optionally an “air-to-liquid” converter. Combinations of aerosol concentrator modules and aerosol collector modules are also “air-to-liquid” converters, having greater concentrative power than aerosol collector modules alone.

“Analysis module”—refers to an apparatus or subassembly of an apparatus having means for detecting an aerosol particle or constituent of an aerosol particle, and having the purpose of detection and/or characterization of the particle or constituent thereof.

“Means for detecting”—as used herein, refers to an apparatus for displaying and optionally evaluating a test endpoint, ie. a result of an assay. Detection endpoints are detected and evaluated by an observer visually, or by a machine equipped with a spectrophotometer, fluorometer, luminometer, photomultiplier tube, photodiode, nephlometer, photon counter, voltmeter, ammeter, pH meter, capacitative sensor, radio-frequency transmitter, magnetoresistometer, or Hall-effect device, and so forth.

Magnifying lenses, optical windows, lens flats, waveguides, and liquid waveguides, may be used to improve detection. Means for detecting may also include “labels” or “tags” such as, but not limited to, dyes such as chromophores and fluorophores; radio frequency tags, plasmon resonance, radio labels, Raman scattering, chemoluminescence, or inductive moment as are known in the prior art. Fluorescence quenching detection endpoints (FRET) are also anticipated. A variety of substrate and product chromophores associated with enzyme-linked immunoassays are also well known in the art and provide a means for amplifying a detection signal so as to improve the sensitivity of the assay, for example “up-converting” fluorophores. Also comprising detection means are liquid chromatography (LC), high pressure liquid chromatography (HPLC), electrochemistry, polarography, electrochemical impedance spectroscopy (EIS), surface plasmon resonance (SPR), high pressure liquid chromatography with mass spectroscopy (HPLC/MS), fast atom bombardment spectroscopy (FABS), matrix-assisted laser desorption ionisation mass spectrometry (MALDI/MS), inductively coupled plasma mass spectroscopy (ICP/MS), gas chromatographic mass spectroscopy (GC/MS), Raman spectroscopy (RS), surface-enhanced Raman spectroscopy (SERS), laser induced breakdown spectroscopy (LIBS), spark-induced breakdown spectroscopy (SIBS), lateral flow chromatography, and so forth. Detection systems are optionally qualitative, quantitative or semi-quantitative. Detection means can involve visual detection, machine detection, manual detection or automated detection.

“Preservation Module”—refers to an apparatus or sub-unit of an apparatus for storing microorganisms, including bacteria, fungi, mycoplasma, parasites, and viruses, in a viable but senescent state for one or more days, generally at reduced temperature. Gels and transport media may be used to preserve viability during storage.

“Incompressible flow”—of a gas stream is characterized by a constant density despite flowing over surfaces or inside ducts. A flow can be considered incompressible as long as its speed is relatively low. A Mach number of about 0.3 is generally used to distinguish between incompressible and compressible flows of air; incompressible flows of air have a velocity of less than about Mach 0.3.

“Compressible flow”—of a gas stream is characterized by changes in density with respect to pressure along a streamline. Density in calculating flow regime may not be taken as a constant. In general, this is the case where the Mach number in part or all of the flow exceeds about 0.3, although the transition from incompressible to compressible is not a precise demarcation, and mixed flow regimes may occur. As exploited here, a progressive particle trap of the invention, which may achieve gas stream velocities in the range of 60 to 100 m/s at its narrowest point, may include regions of both incompressible and compressible flow.

The incompressible and compressible flow regimes produce many associated phenomena, such as boundary layers and turbulence. “Turbulent flow” is characterized by chaotic, stochastic property changes in the flow. This includes low momentum diffusion, high momentum convection, and rapid variation of pressure and velocity in space and time. Flow that is not turbulent is called “laminar flow”. Both a laminar boundary region and a turbulent boundary region having eddies of a characteristic scale are recognized. Unless the context requires otherwise, throughout the specification and claims which follow, the word “comprise” and variations thereof, such as, “comprises” and “comprising” are to be construed in an open, inclusive sense, that is as “including, but not limited to”.

Scope of Aerosol Particulates

Particles which may be collected and analyzed by devices, methods or apparatus of the invention include biological agents, particulate toxins, explosives and chemical agents, as well as environmental or industrial mists and dusts, and so forth. The centrifugal particle traps of the invention are configured to operate in various size ranges, in one embodiment trapping particles from 0.2 microns to 50 microns, and in other embodiments from 0.25 to 20 microns or 0.25 to 10 microns, or 2 to 20 microns, while not limited thereto. Aerosol particles ranging from 0.01 to 25 microns are more likely to be hazardous. Particles less than 10 microns in apparent aerodynamic diameter (Dₐ) are recognized as posing a particular respiratory threat, and those less than 2.5 microns are of especial concern, as these can be inhaled deeply into the lung.

Bacterial and fungal particles range from sub-micron to several microns in mean diameter, and can be larger as clusters. For example, as reported by Weis, weaponized bacterial spores associated with transmission of anthrax were shown to be in the range of about 0.65 to 3.1 microns Dₐ, and could be reaerosolized after sedimenting on an environmental surface (Weis, C P et al. 2009. Secondary aerosolization of viable Bacillus anthracis spores in a contaminated US Senate Office. JAMA 288:2853-58). Pox virus particles are one of the largest viral particles, ranging up to 0.1 microns in diameter, and are widely disseminated as free-floating particles in dusts and aerosols in some parts of the world. Other virus particles such as flu virus are more characteristically associated with aerosolized cough secretions, which progressively decrease in size due to evaporative water loss, starting at 1-4 microns and falling within a meter after ejection to a mean of about 0.6 microns (Fang M et al. 2008. Aerodynamic properties of biohazardous aerosols in hospitals. Hong Kong Med J 14(S1):S26-28). Explosives residues may be crystalline in nature and may become aerosolized from packages or surfaces during inspection. Crystals in the range of 0.2 to 20 microns are readily trapped in the centrifugal particle traps of the invention.

Generally, aerosols exist as mixed populations of species having varying sizes and densities, and thus exist with a range of Dₐ. There is a need for particle traps capable of sorting particles by size and for reducing interferences of inert oversize materials such as dust motes without loss of sensitivity in capturing particles of interest as hazards. The centrifugal particle traps of the invention sort particles by Dₐ on a single extended concave impactor surface such that larger or heavier aerosol particles are impacted proximate to the upstream end of the trap and smaller or lighter particles are impacted proximate to the neck, as will be discussed further below.

Engineering of a Progressive Cut-Size Centrifugal Impactor

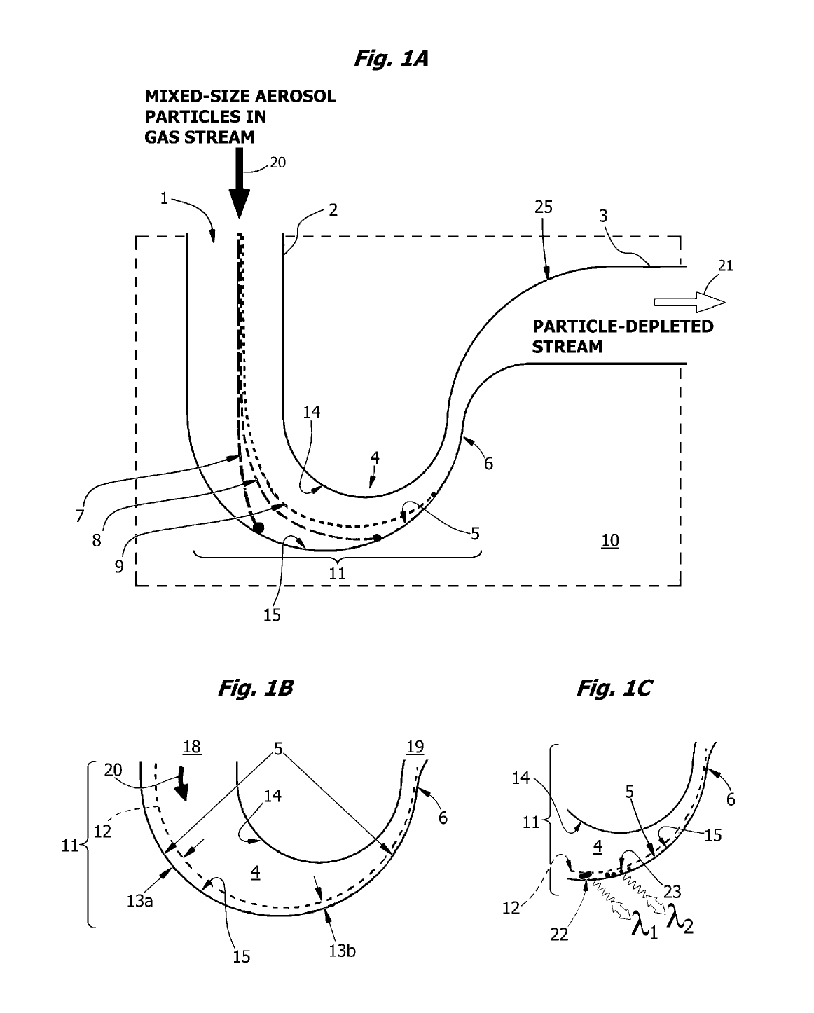

The following drawings of centrifugal impactors and particle collection and analysis apparatus of the invention illustrate the concept of a progressive centrifugal particle trap having a continuously graduated cut-size and curvature, where the cut-size varies from larger at the upstream end of the trap to smaller at the downstream end of the neck. The critical dimension of the particle trap is continuously narrowed to achieve this effect. Consequently, gas flow velocity progressively increases and boundary layer thickness progressively decreases from upstream end to downstream end. Because the inside surfaces of the collector channel are formed with a concavoconvex curvature (i.e. having a concave inside surface and a convex inside surface), inertial impaction is graded: higher Dₐ particles impacting proximate to the upstream end of the trap and lower Dₐ particles impacting proximate to the neck or throat. However, the critical dimension is most constricted only in the neck or throat, which forms a discrete “pinch point” in gas flow, so that the overall pressure drop in the particle trap is substantially less than a centrifugal impactor having an equivalent cut-size but with constant depth, diameter or L_{c}. Reduction in pressure drop achieves reductions in cut-size and permits transition to compressible flow regimes approaching the neck or throat of the device. These characteristics are illustrated further in FIGS. 1A through 1C.

Turning first to FIG. 1A, a general schematic is depicted of a centrifugal particle trap 10 with progressive narrowing of the critical dimension and decreasing cut-size from upstream to downstream through the trap (4). The centrifugal particle trap (10) may be viewed as a standalone device, for example enclosed in a compact body or block of material, but is frequently combined with other components of aerosol collection and analysis apparatus as indicated by drawing the enclosing box with a dotted line. The device (10) contains a collector channel (1) with a receiving arm (2) and an outlet arm (3). In operation, a particle laden gas stream (20) enters the receiving arm, is conducted through the particle trap (4) and exits as a particle-depleted gas stream (21). A downstream suction pressure source fluidly connected to the outlet arm drives the gas stream. The flow regime and flow velocity are generally determined by a critical dimension of the collector channel, most commonly its least dimension in cross-section. Whereas conventional collectors of this sort have been fabricated with a fixed critical dimension, the collector channels of the invention are characterized as having a concavoconvexedly curving subsection (11) with upstream end, downstream end, length, and curvature, with lumen separating a concave inside surface (15), a concave inside surface (14), the concave inside surface forming an elongate centrifugal impactor surface (5) extending from the upstream end through the neck (6) or Venturi, where the lumen of the trap (4) is seen to be progressively tapered; widest at the upstream end and narrowest at the neck. The downstream end optionally is configured as a diffuser (25) and is widened accordingly.

Particles impact the outside wall of the curved subsection according to their inertia and are captured by collision on the elongate centrifugal impactor surface (5). Three particle traces are shown to illustrate the phenomenon. Gas streamlines are not shown and curve smoothly along the inside surfaces of the trap without intersecting the walls. In a first case, a large particle follows trajectory (7, dashed line), deflecting little as it enters curved subsection (11) and impacting the wall not far from the upstream end of the trap. A medium-sized particle (i.e. having an inertia less than that of the largest particle) is more sharply deflected as it enters the U-shaped section and its trajectory (8, dashed line) collides with the wall at a point of intersection more than half way through the trap. A smaller particle has a trajectory (9, small dashed line) that collides with the concave inside wall near the neck, where velocities are highest.

Larger particles impact early in the process, where the collector channel is relatively wide and slightly curved, smaller particles impact further into the bend where the channel has narrowed significantly. The process of centrifugal impaction requires only that the gas streamlines bend more rapidly than the trajectories of the particles.

Conventionally, the curved subsection (11) of the collector channel is fabricated with a critical dimension (depth or diameter) that is held constant. The critical dimension of the overall channel determines the velocity and from the bending curvature, the cut-size size of the particle trap can be determined. At a given z-dimension the cut-size of the particle trap is a constant for any particular operating conditions. Although the cut-size of U-tube centrifugal impactors has been modified by inserting a disk with narrow central orifice into the tube, the prior art to our knowledge has not graduated the critical dimension of a centrifugal particle trap so that the cut-size is varied as a function of the curvature and the critical dimension.

General expressions for the mathematics of centrifugal inertial particle impact are well known (Hinds, W C, “Aerosol Technology: Properties, Behavior and Measurement of Airborne Particles”, 1982, Wiley-Interscience). Slip coefficients may be used for calculating cut-size parameters for sub-micron particles. The behavior of particles flowing through a curved geometry can be described by Newton's first and second laws. However, these calculations typically assume a constant critical dimension L_{c} representative of the state of earlier technologies. Thus, use of a variable critical dimension (i.e. a progressive taper) in the curved or bending section of a centrifugal particle trap represents an advance in the art and achieves a continuously graduated cut-size.

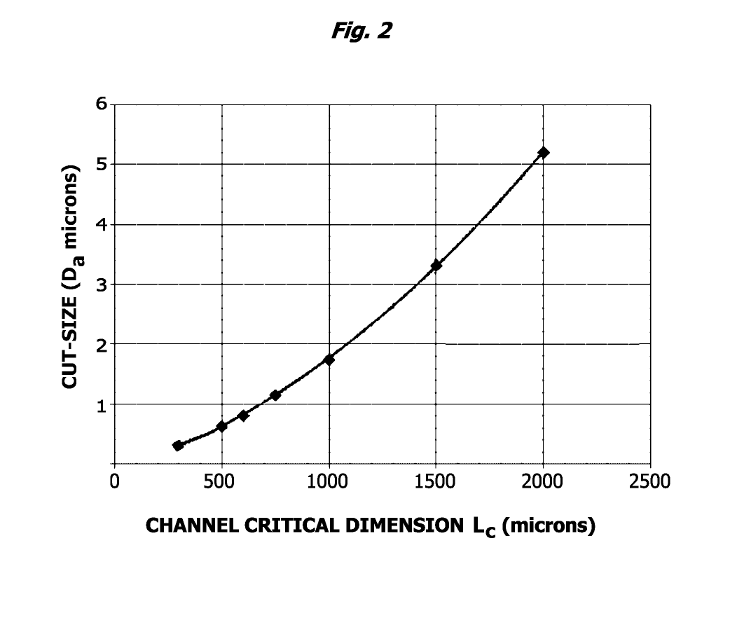

In one recent study, we determined particle cut-size sizes for a series of particle traps of defined bending radius at V_{DOT}=0.5 sLpm and variable tube ID (i.e. progressively tapered) with smallest critical dimension ranging from about 300 to about 2000 microns. The data are shown in FIG. 2. As can be seen, the channel critical dimension required to achieve a particle cut-size of about Dₐ=0.3 microns is about 300 microns diameter at the neck or throat. The pinch point at the neck or throat where the flow regime permits transitioning the flow rate from incompressible to compressible in the curved section (11). Further reduction of the channel internal dimension leads to the compressible flow regime for a given flow rate (exceeding Mach number>0.3) upon which capture of particles and a cut-size below 0.25 microns can be achieved, for example 0.2 microns or even 0.1 microns. If these conditions had been attempted with a conventional centrifugal particle trap of constant diameter instead, the pressure drop would be much higher, and increasing the particle load with mixed particle sizes would rapidly block the trap. Progressively tapered centrifugal impactors may have tubular or slit geometry in cross-section, but the principles remain the same.

The inventive device thus serves the purpose of multiple devices of the prior art, spanning a range of cut-sizes from one end to the other. The device of FIG. 1 achieves an ultimate cut-size that is equivalent, but resists blockage or choking because larger particles are trapped upstream in areas of the curvature having larger diameter and a correspondingly larger unstirred layer and cut-size. Although blockage at saturating particle loading cannot be indefinitely forestalled, the tapered geometry of the centrifugal particle traps disclosed here delays blockage or fouling over extended periods of operation, an important consideration in selecting a particle trap for aerosol surveillance because resistance to fouling often determines operating life and the frequency of need for preventative maintenance or replacement.

In FIG. 1B, it can be seen that the elongate centrifugal impactor surface (5) extends entirely around the concave inside curvature (15) of the particle trap. Larger particles are trapped closer to the upstream end (18) than smaller particles, which are trapped in proximity to the narrow neck (6) near the downstream end (19) because of the combined effects of increasing velocity, curvature, gas viscosity, graduated thickness of boundary layer (12) and particle inertia. The impactingly captured aerosol materials are collectively termed an “aerosol sample”.

In these devices, submicron aerosol particles may be collected in the presence of large dust motes, pollen, and so forth. Depending on the operating conditions and configuration, the gas flow regime can be forced from incompressible to compressible in a transition zone between the upstream end (18) and the downstream end (19) of the tapered section (11). Flow velocities can approach or exceed Mach 0.2 as the flow stream is drawn through the neck 6 with a significant savings in power requirements as compared to constant diameter particle traps. This effect on flow regime also increases the resolution of the improved particle traps with respect to Dₐ. While larger material is collected near the inlet end of the particle trap, submicron materials are also collected, but are physically separated and closer to the neck or throat.

Thus there is a sort of inertial chromatography where a mixture of particles in the aerosol sample is resolved by distance according to particle Dₐ over the extended surface of the impact zone. This permits an unexpected selectivity of analysis, where certain particle sizes may be of particular interest, for example bacteria are more typically in the range of 1-3 microns Dₐ, whereas viruses and dried sputum droplets are smaller than 1 micron Dₐ, and the particles of interest are physically separated from potential interferences. The particles will be distributed as a comet-shaped mat or carpet roughly by size along the elongate inertial impaction surface (5) and may be examined or collected as subfractions thereof.

This can be seen in FIG. 1C, where a detail of a particle trap is presented to show the collection of a larger particle (22) and a smaller particle (23) on the elongate centrifugal impactor surface (5). The larger particle is shown with a rod shape characteristic of a bacillus for illustration. The smaller particle may be for example a soot particle. The two particles are sufficiently physically separated by the action of the progressively tapered centrifugal impactor of the invention that independent optical interrogation is possible. Interrogation at first wavelength (λ1) for example may be conducted independently of interrogation at a second wavelength (λ2), so that the absorbance, scattering, or fluorescence properties of the bacillus (22) are more readily differentiated from the optical properties of the soot granule (23). Optionally, particular zones of the centrifugal particle trap associated with particular types of particles can be identified for further analysis. Or optical sensors, such as pencil lasers, can be scanned along a transect covering one end of the particle trap to the other. A light waveguide may be used in concert, for example, to perform evanescent wave spectroscopy. Thus the progressively tapered centrifugal impactor surface (15) provides improved means for resolving and identifying individual particle species of interest or constituents thereof. The particle traps of the present invention may be interfaced with various photometers, where “photometers” are taken here broadly to include spectrophotometers, nephelometers, luminometers, fluorometers, and so forth, including evanescent wave spectrophotometers such as Raman spectroscopy (RS), surface-enhanced Raman spectroscopy (SERS), laser induced breakdown spectroscopy (LIBS), spark-induced breakdown spectroscopy (SIBS), surface plasmon resonance (SPR), or methods using fluorescence of particle constituents, where photometry has the purpose of identifying particular aerosol species or constituents of interest. Detection of radiation emissions may also be performed in situ without solubilization or transport of the aerosol sample from the particle trap. Alternate detection functionalities suited for analysis and identification of an aerosol particle or constituent thereof, a biological particle or constituent thereof, or an explosives residue or constituent thereof, may be interfaced with the centrifugal particle trap as required. Electrometry, where electrodes are used to measure conductance or potential at points on the impactor surface in the trap is also useful.

Since the velocity of the gas stream (20) is highest in the neck, there is a corresponding change in the thickness of the boundary layer (12) as shown in FIG. 1B. Nearer the upstream end, the boundary layer is thicker (13a) and nearer the downstream end 19 the boundary layer is thinner (13b). The dimensions of the figure are exaggerated for clarity, however, a thickness on the order of 25 microns is readily achieved at the upstream end, while reduced to 10 microns or less approaching the neck. Thickness achieves an unexpected benefit. A particle such as bacillus (22) impacting a thicker laminar boundary layer (12) settles into the unstirred layer at zero velocity and is less likely to be sheared or desiccated by virtue of being fully immersed in the boundary layer at rest. This is of interest for biological particles where the collection of viable cells such as bacteria, fungi or viruses is frequently of interest. Collection of viable bacteria is difficult in particle traps having a small critical dimension because the linear velocity is high and the boundary layer is correspondingly thin in order to achieve a satisfactory cut-size. As had not been previously realized, biological particles such as bacteria settle in the trap in areas of a thicker boundary layer in the progressive cut-size particle traps of the invention, and are thus not smeared or rolled on the inside wall or impacted at velocities where the collision is essentially irreversible. Bacteria that settle at zero velocity onto the wall are more viable and more readily detached for collection and transport from the particle trap, a welcome advance in the art. In preliminary experiments, up to about 75% viability of trapped bacterial cells was achieved.

These particle collectors accommodate incompressible, compressible, subsonic and transonic flow regimes. Thus the cut-size size range may be extended to 0.2 microns or less at the neck (6, or at the “throat” when using a diffuser), while retaining a cut-size size of up to 20 or even 50 microns at the entry subsegment of the bend. These designs are thus termed progressive cut-size particle traps to distinguish them from the constant geometries of earlier work and represent a technological advance in the art. At about 60-100 m/s, particle behavior departs from extrapolations based on incompressible flow. The incompressible flow regime can be exceeded in constant diameter round channels (d=300 microns) at 0.5 L/min, but the resistance through the channel is much greater than a corresponding progressive cut-size particle trap operated with the same flow volume. Progressive cut-size particle traps having a minimum critical diameter of 250 microns may be operated at about 0.5 L/min; having a minimum critical diameter of 500 microns at about 1.0 L/min. It should be noted that the actual sampling rate is dependent on the flow split of the upstream aerosol concentrator, so that actual sampling rates ranging from 10 to 50 L/min are readily achieved. These flow requirements may be met with palm sized, commercially available pumps. Larger flow rates, up to 250 L/min, with a minor flow of 1-2 L/min, are also feasible as judged by work to date.

In the compressible flow regime, there is less scattering because the rarified atoms of the streamlines experience fewer collisions and more limited thermophoresis. Decreased scattering increases the resolution of the particle trap based on particle size and also the sensitivity. Improved collection efficiency for sub-micron particles results.

Particles in the 0.25-50 micron size range may be targeted by modifying the effective area of the collector, the progressivity of the taper, and the geometry and curvature of the curved subsection for a given gas flow rate. The combination of these parameters determines the operating conditions and the particle capture efficiencies. Larger particles (having greater inertia) are deflected less by viscous drag than the smaller particles. This causes the larger particles to impact on the wall of the progressive cut-size collector sooner (as shown in FIG. 1C above). The smaller particles travel further through the collector channel before being collected in the narrower section of the collector where the gas velocities and the centrifugal forces acting on the particles are greater. Particles in the 0.1 to 0.5 micron range may also be collected by adjusting the design and operating parameters of progressive cut-size particle traps operated in single-pass mode.

A gas-to-gas concentrator such a “skimmer” of the prior art may be fluidly connected to the inlet arm. These virtual impactors are typically used with an intake nozzle or aerodynamic lens to improve performance. Arrays of aerodynamic lenses may also be used on the intake side. Using these devices a concentrated stream of particles termed a “minor flow” is delivered to the centrifugal particle traps of the invention.

In addition to the planar bending curvature of the particle trap channel of FIG. 1, three dimensional curves, spirals and loops may also be used, the distinguishing criterion being the progressive tapering or narrowing of the collector channel as the curve tightens. While the curvature of the particle trap exhibited in FIG. 1 is formed with a constant outside wall radius of bending, other two-dimensional curvatures may also be used, such as an involute of a circle, a “golden spiral”, a logarithmic progression, or Fibonacci proportions, as in the shell of a Nautilus, and so forth. Other configurations are suggested in FIGS. 9, 10 and 11. The curve selected will typically be truncated at some overall length and transitioned to an adaptor having generally parallel walls forming an inlet arm or receiving arm and an outlet arm terminating in an outlet orifice to which the suction pressure source is attached.

Manufacture of these devices is contemplated by molding arts as described in co-pending U.S. patent application Ser. No. 12/364,672 where the male molds are adapted to support the taper of the channel as shown here. Typically a clamshell construction is used. Inlet ports may be on the order of 1 cm or less for most applications, with a critical dimension of the neck of about 1-2 mm or so, but may be scaled in size to economize on suction pump power requirements. Stereolithography may also be used.

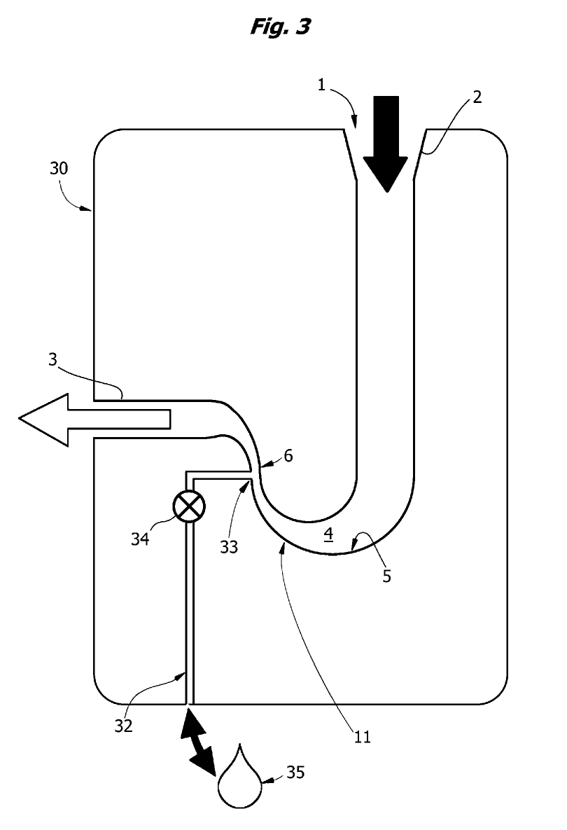

As shown in FIG. 3, the collection device may be contained in a compact collector body (30), for example conveniently made of molded plastic. The particle trap (4) includes a curved subsection (11) characterized by a progressive narrowing in the critical dimension. The velocity of the gas stream increases progressively from inlet to outlet, and can approach a compressible flow regime in the neck at velocities of 60-100 m/s or higher. Particles are impacted and trapped generally according to their size, and form a comet-shaped mat or carpet on the elongate impactor surface formed of the inside wall of the curved subsection of the collector channel. Larger particles are trapped before obstructing the limiting dimension of the neck or throat (6), so that the progressive cut-size traps of the invention are versatile and may be used in the presence of larger particles or larger particle concentrations without the inconvenience of frequent blockage. The centrifugal particle trap includes a collection duct (1) with intake arm or end (2) and outlet arm or end (3), and a concavo-convexedly curved or bent section (11) with elongate centrifugal impactor surface (5) that comprises the particle trap (4) per se. According to another embodiment of the invention, the aerosol collector module (61) is a small block of plastic with embedded collector channel and particle trap, which is removed so that an aerosol sample may be forwarded to a separate workstation for sample preparation and analysis. Closure means are provided for sealing the block during transport and storage.

Optionally, particles collected in the trap may be examined in situ or treated in situ. A reagent or reagents may be added through the inlet or outlet arms or may be added via an injection duct (32) adapted specifically for that purpose. The injection duct joins the collector channel at a “tee” (33) in the particle trap. It may be preferable to locate the tee downstream from or upstream of the impactor surface. The tee is generally proximate to the elongate inertial impactor surface (5).

The injection duct is typically provided with a valve (34) and is connected to a reagent fluid reservoir (not shown) with associated pumping functionality. During the sampling process, the gas stream and suction pressure is turned off or redirected using valves or stopcocks.

A liquid reagent injected through injection duct contacts and dissolves, solubilizes or reacts with any deposited aerosol particles or constituents thereof in the particle trap. The resultant liquid sample, containing a solution or suspension of the aerosol particles, is optionally analyzed or treated in situ or is conveyed to an external port for downstream analysis. The collector in this configuration thus serves as a gas-to-liquid concentrative collector.

To collect the liquid sample, if desired, an auxiliary pump may be used, or the pump utility may be configured to be bidirectional. In another embodiment, the sample liquid can be conveyed under differential pressure out of the collector body through the outlet arm. Liquid sample may be analyzed or optionally retained for future analysis. Alternatively, the highly concentrated sample liquid can instead advantageously be analyzed in situ in the collector channel with a suitable analytical apparatus, such as photometric analysis of the sample via an optical window in the collector body. While not limited by particularities of detail, these methods of collection and analysis are generally applicable. Dry solids in the particle trap may also be analyzed without liquid elution as described above.

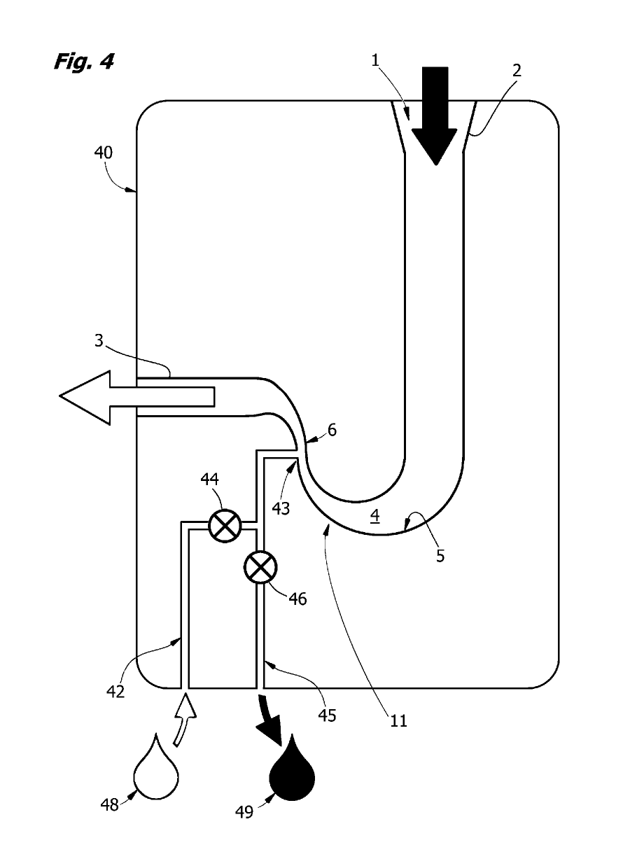

FIG. 4 depicts a more complex embodiment of a collector apparatus or module of the invention for liquefying an aerosol sample. The collector body (40) is configured with a progressive cut-size particle trap (4) having a concavoconvexedly curved subsection (11), an elongate centrifugal impactor surface (5) and accessory ductwork. A particle-rich gas stream entering the collection duct (1) at the top through receiving arm (2) transits the particle trap (4) and a particle-depleted gas stream exits through outlet arm (3). In this example, a more complex fluidic network is associated with the particle trap, and includes provision for inlet of elution reagent and outlet of liquid sample containing a liquid concentrate of an aerosol sample.

An embodiment with two microfluidic ducts is shown. Particles captured in the trap are conveyed from the trap for analysis by injecting a liquid reagent into the collector channel. The ducts are generally in fluidic connection with a pump functionality or member for pumping a sample or a reagent, and optionally in fluidic connection with a reservoir (not shown) for dispensing a reagent or receiving a sample. One duct is an injection duct (42) with valve (44) for injecting a first liquid (48(; the second duct is a sampling duct (45) with valve (46), and as shown here both ducts share a common “tee” (43) with the collector channel (1). The ducts can serve for injection of one or more liquid reagents, and the pumping functionalities can be configured so that the liquid sample (49) can be withdrawn from the trap after the captured aerosol material trapped therein is suspended, solubilized or reacted. As previously noted, in a preferred embodiment a liquid reagent is used to resuspend or solubilize the aerosol sample, and the liquid sample concentrate is then analyzed in situ in the particle trap.

An optical or acoustic window or light pipe may be formed in the collector body and directed to the particle trap. The optical window or light pipe is used to examine the liquid contents of the eluted aerosol sample in place in the trap. Waveguides mounted centrally in a channel in communication with the liquid sample may also be used for in situ analysis, as has been described in U.S. Pat. Nos. 60,821,185 and 6,136,611.

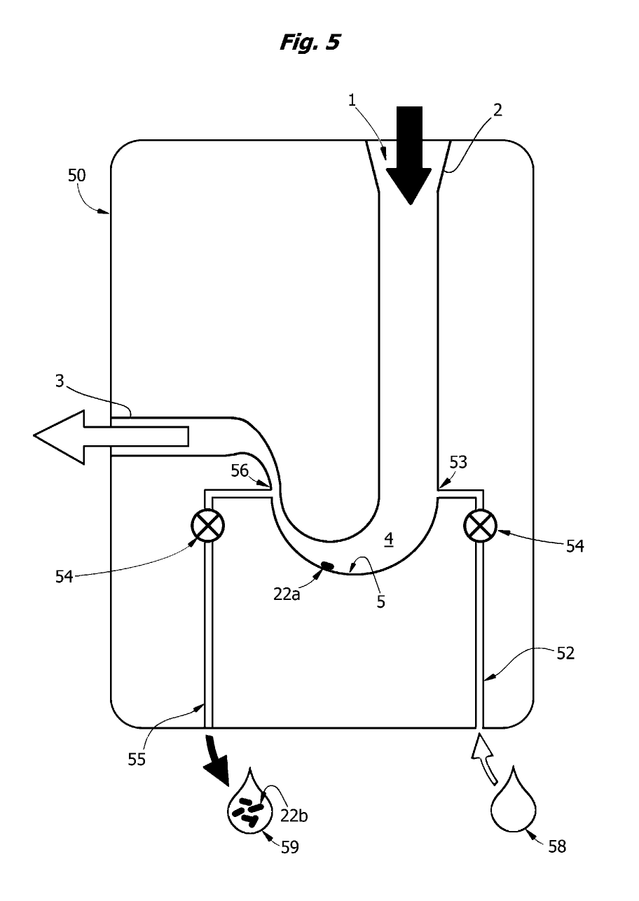

FIG. 5 illustrates an alternative fluidic circuit for preparation of a liquid sample in which a liquid reagent enters from the right and exits on the left. The flow direction could also be reversed if desired. The collector body (50) is configured with a progressive cut-size particle trap (4) having a concavoconvexedly curved subsection, an elongate centrifugal impactor surface (5) and accessory ductwork. A particle-rich gas stream entering the collection duct (1) at the top through receiving arm (2) transits the particle trap (4) and a particle-depleted gas stream exits through outlet arm (3).

One duct serves as an injection duct (52), entering at a first “tee” (53); one duct as a sampling duct (55), exiting at a second “tee” (56). Valves (54) control the motion of fluid in the ducts. Alternatively, fluid or air can be introduced into the ducts so as to alternate the direction of motion of a droplet or droplets in the trap.

In this figure, a first liquid reagent (58) is injected through valve (54) and wets the lumen of particle trap (4). A single bacillus (22a) is shown adherent to the inside impactor surface (5). Other bacilli (22b) are shown to have been resuspended in a fluid droplet (59) and conveyed from the trap via sampling duct (55).

Reagent fluids include elution reagents, analytical pre-processing reagents, and detection reagents. Elution reagents are formulated to resuspend and solubilize the captured aerosol particle mass. These reagents are generally aqueous, but may include co-solvents such as dimethylsulfoxide, N,N-dimethylformamide, N-methyl-pyrrolidinone, 2-pyrrolidone, acetone, Transcutol® (Gattefosse, FR), acetonitrile, acetone, methylethylketone, methyl tert-butyl ether (MBTE), tetrahydrofuran, and so forth. The co-solvent is generally miscible with water but if not may be formulated as an emulsion or microemulsion or used without water. Surfactants and wetting agents as are generally known in the art are also suitable for formulation in an elution reagent. Such surfactants may include Tween 20, Brij-72, Triton X100, Pluronic F68 (BASF, Florham Pk, N.J.), n-acyl-glutamate (Amisoft®, Ajinomoto, JP), Envirogem® 360 (Air Products, Allentown Pa.), Eccoterge® AEP-20 (Eastern Color, Providence R.I.), sodium lauryl sulfate, and so forth. A more comprehensive list of surfactants, co-surfactants and wetting agents may be found in McCutcheon's Emulsifiers and Detergents (2008 Edition). Also useful for eluting biological samples are salts, buffers, surface active agents, cosolvents, osmolytes and nutrient factors, such as may be used to formulate transport media for the preservation of viable microorganisms and viruses. Analytical pre-processing reagents include for example chaotropic salts or urea, such as described by Boom (U.S. Pat. No. 5,234,809), or alkaline SDS lysis solution containing 200 mM NaOH and 1% SDS, as are known to aid in the lysis of bacterial cells, and also enzymes such as lysozyme, achromopeptidase, chitinase or mucopolysaccharidases. These reagents serve to prepare the sample in situ for analysis and to release any bioaerosol material from a sample matrix. Detection reagents include antibodies, probes in general, nucleic acid intercalating agents, chromogenic reactants, dyes, hydrogen peroxide for detection of catalase, NADH or NADPH for the detection of dehydrogenases, ATPases, pyrophosphatases, and so forth. Detection may also be performed by PCR, or by other nucleic acid amplification and probing technique known in the art.

Reagents can be injected into the device in sequence, for example an elution reagent can be injected first, followed by an analytical pre-processing reagent, followed by a detection reagent, or other permutations as are effective in achieving the desired result. In some cases, one reagent serves multiple functions. In some instances, a dry reagent can be placed in the collector channel or particle trap prior to collection of a sample, having the purpose of later being rehydrated by contact with a liquid reagent so as to react with the aerosol sample or a constituent of the sample. While not limiting thereto, dry reagents include a hydrolytic enzyme such as lysozyme or chitinase for digesting a sample, a chromogenic or fluorogenic dye such as ethidium bromide or tetrazolium blue for staining a sample, or an antibody with fluorescent probe conjugate, for example. Elution of aerosol particles by dispensing an elution reagent onto the impactor surfaces as provided in the present invention is achieved by any of several species of small pumps or pump functionalities which can deliver fluids through microfluidic channels at very low volumetric flow rates and useful linear velocities. These pumps include piezoelectric dispensors, inkjet printer heads generally, positive displacement pumps, syringe pumps, microfluidic diaphragm pumps, magnetostrictive diaphragm pumps, electrowetting devices, thermopropulsive pumps, Gibbs-Marangoni devices, and hybrid devices such as piezoelectric dampeners or diffuser-nozzle heads on a syringe pump. Also contemplated are binary droplet devices.

Applying a pressure differential across the collector channel is one elementary approach for moving a liquid. Differential pressure in the collector channel arms may be used to draw or push a fluid onto or across the impactor surface. Thus, also within the sense of “pump functionality” is any application of suction pressure, hydraulic pressure, or pneumatic pressure.

While not shown, pump functionalities may be bidirectional and self-priming, thereby eliminating the need for two pumps. A single, bidirectional pump functionality may be used to both inject a liquid reagent and withdraw a liquid sample from particle trap. Suitable valves are also well known in the art. Various microscale fluid control devices are well suited for incorporation in the collector modules and associated particle collection apparatus of the present invention and for directing and controlling fluid reagents injected into and liquid sample withdrawn from the collector.

Turning to FIG. 6, a modular aerosol sampling apparatus (66) with progressive cut-size centrifugal impactor is shown to demonstrate integration of the centrifugal impactor with other modules of an aerosol handling apparatus. All modules are fluidly connected and are configured to function as an aerosol-to-liquid concentrative collector with liquid sample analysis module (63) at the back end. The intake module, an aerosol concentrator module (61), is capable of processing 20, 30, 1000 or more liters per minute of a gas at the intake and diverting a major fraction of that gas, depleted of particles, to a concentrator exhaust (68). The particle-enriched gas stream (67, minor flow) is routed in parallel into a second module, which is an aerosol collector module (62) with progressive cut-size particle trap and liquid sampling capability as described above via a sampling duct (65). The sampling duct is adapted for delivering liquid sample (69) to the liquid sample analysis module (63) for analysis. The liquid sample analysis module is configured with detection means suited for analysis and identification of an aerosol particle or constituent thereof, a biological particle or constituent thereof, or an explosives residue or constituent thereof, as may be required.

Integration in construction may be advantageously accomplished by joining the front end modules in an integrated solid body (60) consisting of an aerosol concentrator (61) and an aerosol collector (62) in combination. Integration of liquid sample handling and analysis modules into a single solid body (64) may also be advantageous if desired. All three modules may also be joined in a single integrated device (66). Conversely, it may be advantageous to supply each of the three modules separately, so that, for example, the aerosol collector module and the liquid sample analysis module are disposable. In related aspects, the invention is both an apparatus and a method for collecting an aerosol sample using the centrifugal particle trap of the claims as a gas-to-liquid concentrative collector. The method comprises steps for a) directing a gas stream containing an aerosol particle into a collector channel, the collector channel with concavoconvexedly curved subsection disposed between the intake arm and the outlet arm, wherein the curved subsection has an upstream end and a downstream end separated by a length, a convex inside surface, a concave inside surface, and is tapered with a progressively narrowed critical dimension that narrows from upstream end to a neck of least critical dimension proximate to the downstream end; b) impactingly capturing the aerosol particle on the elongate centrifugal impactor surface within the collector channel, the captive aerosol particle constituting an “aerosol sample”; c) suspending or dissolving the aerosol sample as a suspension or solution in a first liquid injected into the collector channel, thereby forming a “liquid sample”; d) optionally performing a treatment of the liquid sample; e) optionally performing an analysis of the liquid sample; or f) optionally conveying the liquid sample from the collector channel to a sampling port for downstream analysis or archiving. The step for treatment of the liquid sample may include: a) a step for chemical treatment by contacting the liquid sample with a second reagent having the purpose of chemically modifying a constituent of the liquid sample; b) a step for a thermal treatment or an ultrasonic treatment having the purpose of resuspending, dissolving, reacting or lysing the aerosol sample in the liquid sample; c) a step for radiological treatment with microwave or other radiation treatment having the purpose of resuspending, dissolving, reacting or lysing the aerosol sample in the liquid sample; and/or d) a step for mechanical treatment having the purpose of mixing or moving the liquid sample in the collector channel. Once the liquid sample is ready for conveyance to the analytical module, downstream analysis may be by physical, chemical, biochemical or molecular analytical modalities. Analytical modalities include a) a step for inducing fluorescence of specific constituents of the liquid sample, detecting emitted fluorescent radiation, having the purpose of identifying those constituents of interest based on the spectrum of the emitted light; b)a step for measuring optical absorption of the liquid sample at one or more wavelengths; having the purpose of identifying those constituents of interest based on the spectrum of the absorbed light; c) a step for measuring light scattered from the liquid sample at one or more angles of scattering; having the purpose of quantitating or identifying those constituents of interest based on the pattern of the scattered light; d) a step for subjecting the liquid sample to a nucleic acid amplification and detecting an amplicon; having the purpose of identifying those constituents of interest based on the presence of a nucleic acid sequence; e) a step for subjecting the liquid sample to an immunological assay; having the purpose of identifying those constituents of interest based on an antigen:antibody reaction; f) a step for subjecting the liquid sample to at least one spectroscopic measurement technique selected from Raman spectroscopy (RS), surface-enhanced Raman spectroscopy (SERS), laser induced breakdown spectroscopy (LIBS), spark-induced breakdown spectroscopy (SIBS), surface plasmon resonance (SPR), or methods using fluorescence of particle constituents, having the purpose of identifying those constituents of interest; and/or g) a step form measuring a radioactive emission of the liquid sample.

Samples collected from the collector module may optionally be archived in individual containers for that purpose, or stored in the collector module. Using networks of microfluidic channels, sample pre-processing by reagent addition may be performed continuously or in batch mode. With increased complexity, sample collection devices may be fabricated with partial or full integration of detection and/or identification capabilities. In some instances, it may be desirable to stage multiple detection functionalities, providing a threshold signal discrimination capability that triggers a more intensive analytical subroutine.

Collection and Preservation of Viable Microorganisms

For collection of microorganisms, it is sometimes desirable that the sample remain viable for up to several days. Centrifugal particle separation used in prior art biological samplers, such as the SASS 2300, SKC biosampler, or micro-centrifuge personal bioaerosol samplers typically achieve limited viability. The major drawback for viable organism capture in these cyclone systems is that particles in the entire size range are accelerated to high velocities, compromising the viability of the more fragile organisms, which are subjected to high pressure gradients in the jet and high speed impaction on the sampling surface. For example, in the SKC biosampler, sonic jets are needed to capture 0.7- to 10-μm particles (particles smaller than 0.5 μm are typically not captured). Unfortunately, the very low pressure inside the jet associated with sonic velocity can be fatal to bio-organisms. Another limitation of cyclones is their high liquid sample volume and the tendency to re-aerosolize the organism after impaction.

While the progressive cut-size particle trap also relies on particle impaction on the walls of a curved geometry, the progressive cut-size particle collector of FIGS. 1, 3-11 offer several significant advantages. Particles of a given size have just enough momentum (velocity) to penetrate the boundary layer at the impactor wall and will be immobilized upon contact with the wall. Interestingly, particles are decelerated to zero or near-zero velocity in the boundary layer, minimizing impact velocity. Particles with greater momentum (larger aerodynamic diameter) are able to penetrate and are blanketed in the thickness of the boundary layer upstream and settle on the wall where the flow velocities are relatively low and the boundary layer is the thickest. Smaller particles will be captured in the narrower region of the trap where the velocities are higher and the boundary layer is thinner due to flow acceleration, but boundary layer thickness, which can be 10 microns near the narrowest aspect of the neck, is nonetheless greater than the aerodynamic diameter of the smaller particles (0.2-2.5 microns). And because the particles decelerate to zero velocity in the boundary layer cushion, shear associated with impact is minimal. In both cases the particle velocity at its contact with the wall is near zero, as the centrifugal acceleration acting on the particles is slowed by drag and deceleration of the particle in the boundary layer.

After immobilization on the surface in the trap, the particles are held in place by van der Waals forces. Though the core velocity in the impactor is relatively high (50-100 m/s), the particles on the wall are not subjected to high shear stresses due to the low velocities in the boundary layer region, which is thicker than the corresponding entrapped particle diameter.

There will also be a water vapor concentration boundary layer which will allow the humidity at the surface to be greater than that in the free stream and will protect the organism from desiccation during the sampling period. In order to produce an elevated humidity level, and further preserve the viability of collected organisms during prolonged sampling, the collector may be chilled. Keeping the wall of the collector colder than the air stream assists in the development of a thermal (cold) boundary layer at the surface. In turn, the colder boundary layer will result in higher humidity at the surface and potentially water condensation on the wall of the collector. A liquid layer of condensate and mist on the wall of the collector will significantly increase the viability of the bio-aerosols and may be beneficial during the particle elution from the surfaces. The cooling of the micro-collector can be accomplished using a simple thermoelectric (Peltier) cooler or other chiller. Although Peltier devices are not very efficient (˜10%), they are very robust, scalable and easily implemented in a small chassis. Another approach is to integrate collector cooling with a cooled viable sample storage module having a refrigeration unit. Humidity may also be increased by introducing a steady but small flow of water or water vapor into the collector channel. Such chiller combinations are also of use in trapping volatile organic compounds. Optionally, liquid in the trap may be frozen in place, facilitating the preservation of viable organisms (when used with cryoprotectants) and volatile organic compounds.

In order to better retain viability, the aerosol samples are eluted periodically from and delivered to a storage compartment or vial. Fluidic ductwork as shown in FIGS. 3-7 may be modified for this purpose. The frequency, volume and sequence of each elution event may be adjusted to achieve the desired volume for each sampling period as well as the desired final volume in the storage reservoir—which will be integrated into a microfluidic cartridge for ease of sample handling and maintaining sample viability. In these embodiments, elution fluid is formulated to preserve viability. An elution reagent intended for transport typically contains only salts and buffers, but can include osmolytes designed to protect against freeze denaturation of essential proteins and membranes, lyoprotectants, cryoprotectants. Vitamins needed for essential cell functions, oxygen scavengers, and specific components such as glycerol, agarose, polyvinyl-pyrrolidinone, casein, gelatin, albumin, acrylamide, dextran, and so forth. Mild detergents such as Tween 20 or Nonidet P50 may also be used. Such media ideally maintain the viability of all organisms in the specimen without altering their concentration. The lack of carbon, nitrogen, and organic growth factors in the medium is intended to prevent microbial multiplication. Transport media used in the isolation of anaerobes must be free of molecular oxygen. Examples include Stuart transport medium, a non-nutrient soft agar gel containing a reducing agent to prevent oxidation and charcoal to neutralize certain bacterial inhibitors, and buffered glycerol saline for enteric bacilli. Venkat-Ramakrishnan (VR) medium for Vibrio cholerae is an another example. Transport media for viruses include, for example, Richards viral transport, sucrose-phosphate-glutamate (SPG), Virocult, HH medium, tryptose phosphate broth, cell culture medium, and Bartel's viral transport. U.S. Pat. Nos. 4,030,978, 5,109,027 and 5,545,555 are representative of the art. Media may be formulated as temperature sensitive gels, for example by adding low-melt agarose or polymers with a low glass temperature and good characteristics as a hydrogel.

To increase particle recovery from the wall of the collector, several droplets can be moved back and forth in the collector channel several times. If necessary, the liquid containing the collected bio-aerosols can be stored in separate reservoirs to obtain time-resolved samples, or partitioned to preserve different types of organisms.

Alternatively, the collector module may simply be filled with transport medium and gelled or frozen in place. The collector module, preferably a compact solid body with closures for sealing the receiving arm and the outlet arm during transport, is then removed from the aerosol sampling apparatus and transported to a laboratory for further analysis of the aerosol sample.

In another embodiment, a collector channel is treated to form a thin layer of condensate of water (or solvent mixture) on the surface walls of the particle trap and retained at or below the freezing temperature of the condensate during use. The collector channel may be then be warmed to liquefy the surface moisture layer, and the resulting liquid suspension containing any captive particles is readily eluted for sampling.

Combinations of concentrator and collector modules in a single apparatus that will handle anywhere from 10 to 400 Lpm of flow are readily constructed. Particles entrained therein are eluted into a small concentrated volume for storage and transport. Eluates may also be combined in storage containers or vials over the course of a sampling duration, yielding larger samples anywhere from 50 uL to 10 ml, as specified by the user. In a preferred embodiment, the storage cell is a microfluidic cartridge refrigerated at +4 C; these microfluidic cartridges will maintain sample viability for several days.

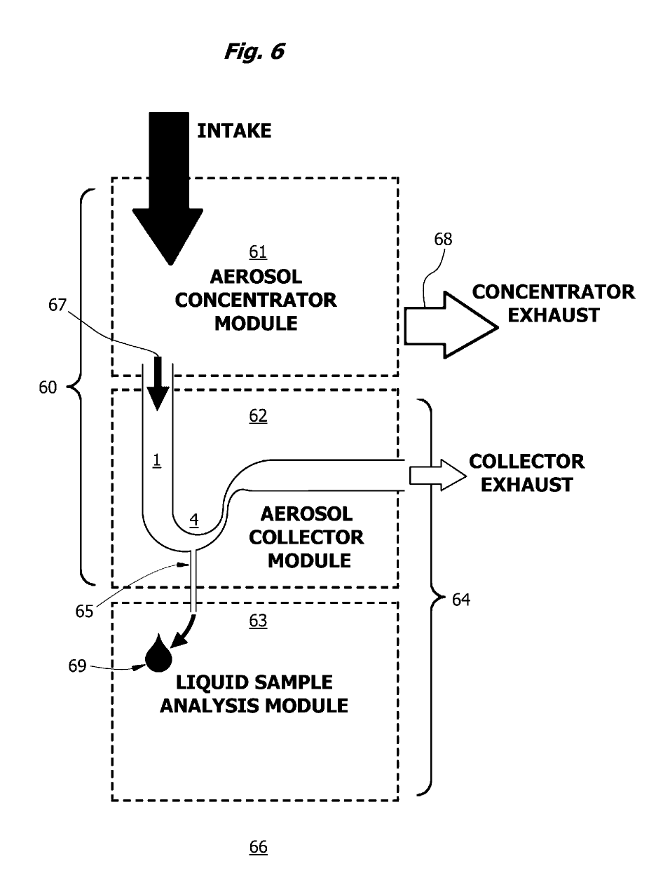

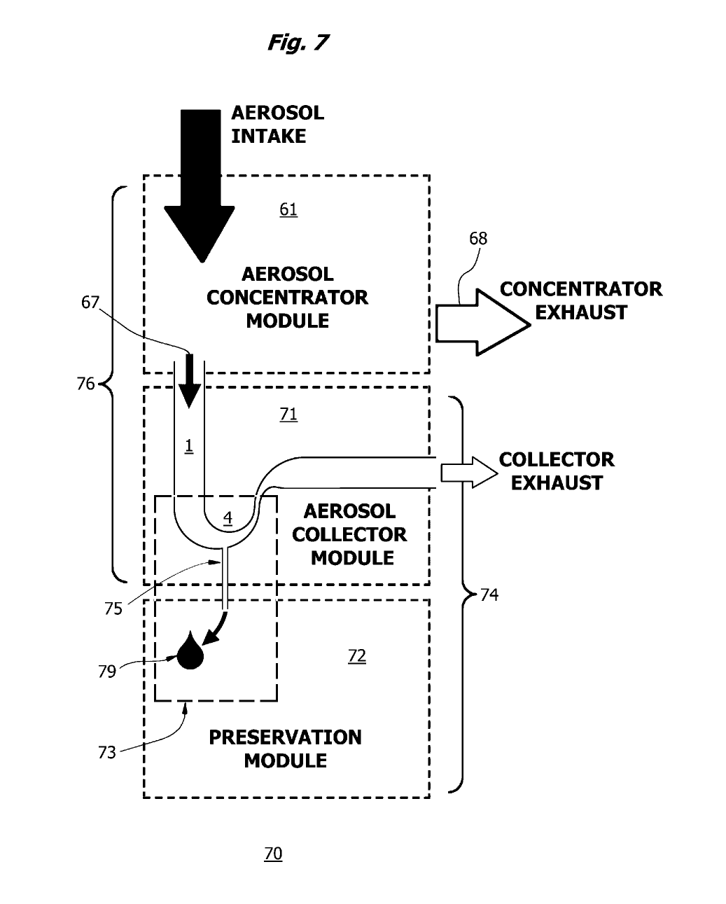

An apparatus for preservation, storage or transport of viable microorganisms captured from an aerosol stream is shown in FIG. 7. The apparatus (70) consists of three modules: an aerosol concentrator module (61, typically including an aerodynamic lens and skimmer), an aerosol collector module (71, here a centrifugal particle trap (4) of the invention, with distinctive curved and narrowing collector channel 1), and a preservation module (72). The modules may be combined as a single unit, housed separately in the apparatus, or joined as combinations of concentration-collection (76) functionality or collection-preservation (74) functionality.

An aerosol concentrator module or device may also be employed to concentrate a particle stream (commonly termed “minor flow”) for entry into the collector device or module. The aerosol concentrator may be provided with an omnidirectional inlet for use where wind is an issue, an inlet filter or screen for rejecting gross debris, and an aerodynamic lens, for example, as have been developed by our laboratory.

In operation, the concentrator module (61) receives an aerosol intake and enriches the gas stream for particles, delivering the enriched stream (67) to the collector duct (1) of the collector module (72) and exhausting the concentrator waste (68). A solid sample accumulates in particle trap (4). This solid sample can then be resuspended or solubilized in a wash reagent, which is then transported through sampling duct (75) to the preservation module (72). Pump functionality for transferring the liquid sample (79) may be part of the collection module or part of the apparatus. The preservation module may be provided with a refrigeration module (73), for example a chiller loop or Peltier heat exchanger, for chilling the sample contents. This chiller unit may be shared with the collector module to cool the particle trap during collection or storage of samples. The preservation module is also optionally provided with reagent reservoirs and storage matrices for preserving viable microorganisms, and may also be used for preserving samples containing volatile organic compounds such as explosives residues.

The preservation module (72) optionally may be detached from the housing apparatus and transported separately. Optionally, individual samples are bottled, encapsulated, spotted, or otherwise distributed for storage in an insertable vial, cartridge or other matrix, and the matrix is transported for later analysis. The preservation module may also, of course, be combined with analytical functions, such as a threshold sensor that triggers further analysis.

Integrated Analytical Module

Also conceived is an aerosol concentration, collection and preservation apparatus that includes an analysis module. The analysis module may have solid analysis capability and be operatively interlinked with the collection trap through a physical interface, or liquid analysis capability, and be operatively interlinked with the collector module through a fluidic works. Physical means are generally performed on dry particulate mass trapped in the collector, such as by incorporating in the particle trap a waveguide, lightpipe, lens, or optical window for interfacing with a photometer. Liquid sample may be analyzed by a variety of means for detecting an analyte, including PCR and in microfluidic cartridges for designed for nucleic acid analysis, for example. Standard microbiological and virological techniques may also be used for enumerating and identifying viable organisms once recovered.

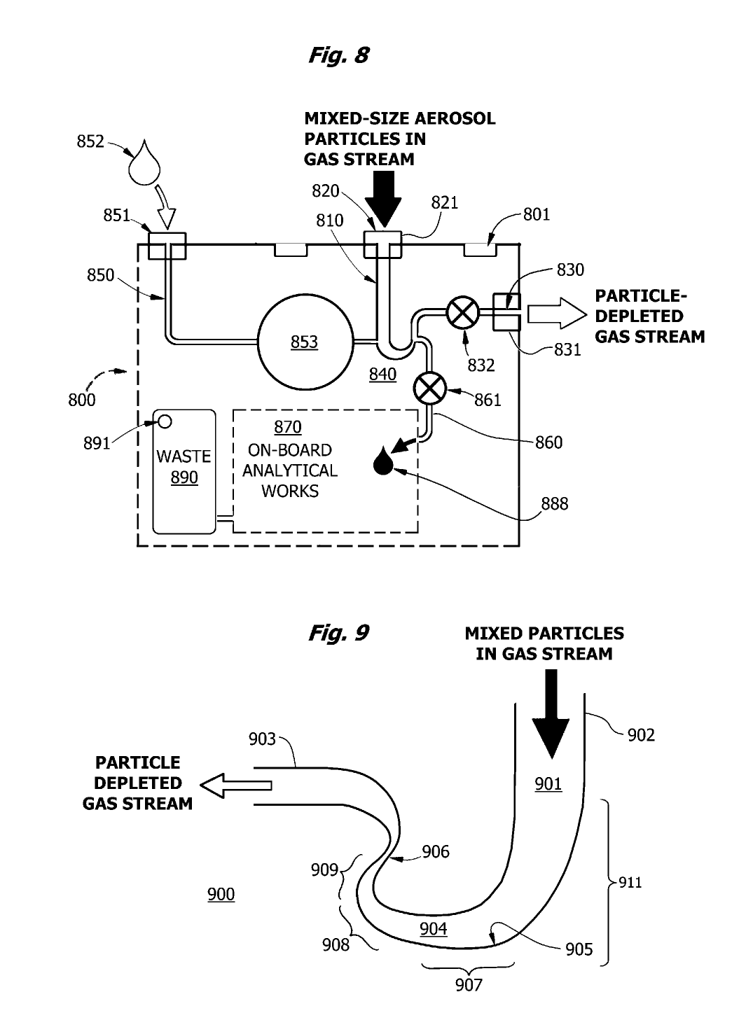

FIG. 8 illustrates a part of a microfluidic cartridge (cut at dotted line) with an on-board progressive cut-size particle trap (840) formed in a plastic cartridge body. Such cartridges may be made by lamination or molding technologies known in the art. The inlet (820) of the receiving arm (810) is detachably attachable via adaptor (821) to an aerosol concentrator, such as the aerodynamic lenses described in US Patent Appl. 2008/0022853, entitled “Aerodynamic Lens Particle Separator”, U.S. patent application Ser. No. 12/364,672, “Aerosol Collection and Delivery for Analysis, and U.S. patent application Ser. No. 12/125,459, “Skimmer for Concentrating an Aerosol”, and are co-assigned to the Applicant. The downstream outlet arm (830) is attached via an adaptor (831) to a suction pressure source such as a vacuum pump for pulling a gas stream through the particle trap. The device receives a mixed population of aerosol particles in a gas stream and exhausts a particle-depleted gas stream.

Also provided is a microfluidic circuit with microfluidic pump (853) for injecting an elution or lysis reagent (852) from an off-cartridge reservoir via injection duct (850) with connector 851. The elution or lysis reagent transits the particle trap (840) and is collected in a sampling duct (860) for conveyance to a microfluidic circuit (not shown) for analysis or other sample processing function. Valve (861) is used to direct flow.

Liquid sample (888) enters an on-board microfluidic analytical works (870) configured for nucleic acid assay, for example by PCR or NASBA, with provision for vented waste (890,891). The microfluidic cartridge is inserted into an instrument intended for operation of the molecular testing and for reading a result of the assay. The cartridge is optionally disposable. Optionally, the microfluidic cartridge may be configured with other chemical or molecular assays as required by the user.

FIG. 9 is a schematic of a collector channel with curved subsection (911) having a progressive tapering and variable critical dimension. The curved subsection has a complex compound curvature so as to more fully localize and isolate particular size fractions of particles, as may be useful in isolating those fractions for in situ analysis or for selective elution.

The device (900) contains a collector channel (901) with a receiving arm (902) and an outlet arm (903). In operation, a particle laden gas stream with mixed particles enters the receiving arm, is conducted through the particle trap (904) and exits as a particle-depleted gas stream. A downstream suction pressure source fluidly connected to the outlet arm drives the gas stream. The collection duct is characterized as having a concavoconvexedly curving subsection (911) with upstream end, downstream end, length, and curvature, with lumen separating a convex inside surface and a concave inside surface, the concave inside surface forming an elongate centrifugal impactor surface (905) extending from the upstream end through the neck (6), where the lumen of the trap (4) is seen to be progressively tapered; widest at the upstream end and narrowest at the neck. The curving subsection can be described as having a complex impactor surface consisting of multiple bending sections (907,908,909) directed at different particle sizes. Here section (907) is envisaged as serving to trap more coarse materials prior to entry of the gas stream into the downstream section dedicated to detection of particular aerosol particles or constituents thereof, biological particles or constituents thereof, or explosives residues or constituents thereof. Alternatively subsection (907) is dedicated to detecting higher density crystalline materials such as explosive residues. The taper and curvature may be configured to best suit the application as required.

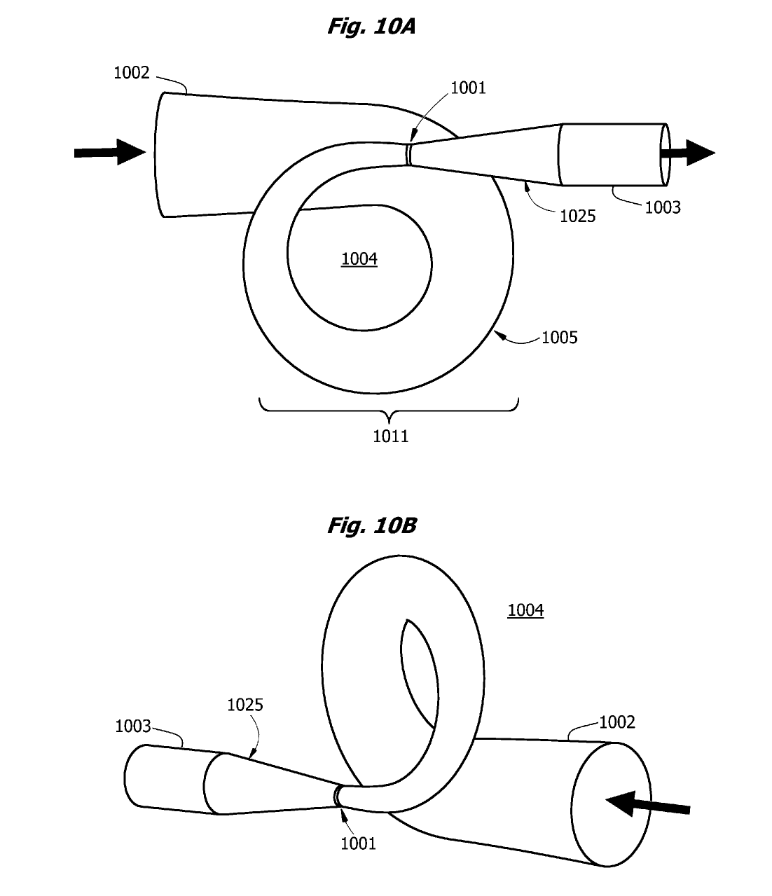

FIGS. 10A and 10B depict a loop collector channel having the same principle of operation as those illustrated above. A gas stream enters an intake arm 1002 and transits a curved and tapering section (1011) before exiting an outlet arm 1003. The curved subsection contains a windward wall termed the “elongated centrifugal impactor surface” (1005, inside wall) of the particle trap (1004). The elongate centrifugal impactor surface extends all the way around the loop of the particle trap, forming a complete 360 degree bend.

A downstream throat (1001) joins the particle trap to a diffuser (1025) which can be operated to achieve compressible flow regimes. In the discussion, neck (6) has been used to refer to a constriction or pinch point at the end of a progressively tapered particle trap and throat is now used more specifically to refer to a constriction joining a progressively tapered particle trap and a diffuser stage for compressible subsonic and transonic operation.

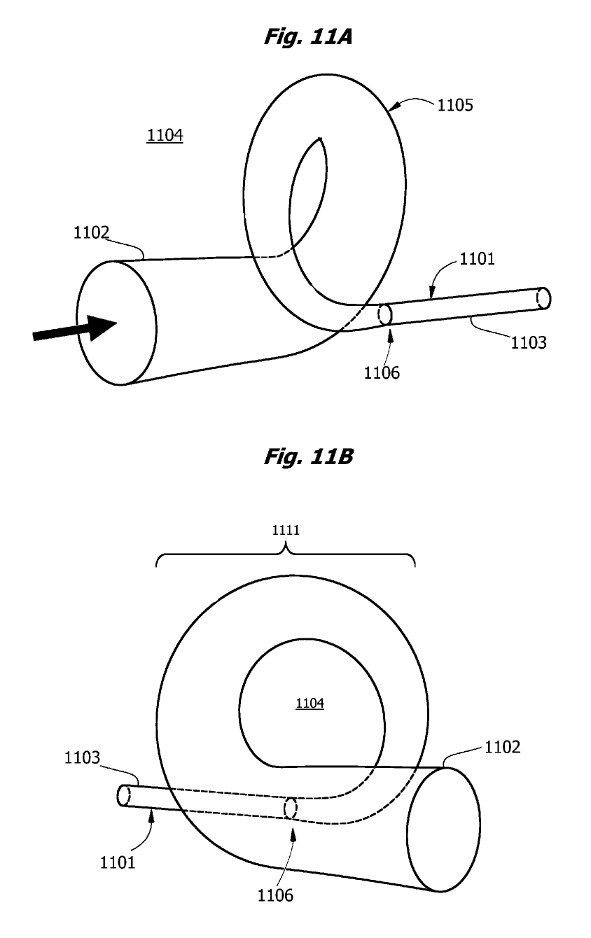

FIGS. 11A and 11B depict a second example of a loop-type centrifugal particle trap (1105), where again the elongated centrifugal impactor surface (1105) extends all the way around the curved and tapering section (1111) loop of the particle trap (1104) between intake arm (1102) and outlet arm (1103). A neck (1106) serves as an attachment point for a tubular adaptor (1101) on the exhaust end.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. The appended claims are not to be interpreted as including means-plus-function limitations, unless such a limitation is explicitly recited in a given claim using the phrase “means for.” In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. An improved centrifugal particle trap having a continuously graduated cut-size, which comprises a collector channel, said collector channel having an intake arm with inlet port for receiving an aerosol particle of aerodynamic diameter Dₐ entrained in a flowing gas stream and an outlet arm for discharging a particle-depleted gas stream, the outlet arm with fluidic connection to a downstream suction pressure source for drawing said flowing gas stream through said collector channel;
wherein said collector channel is characterized by
a) a concavoconvexedly curved subsection disposed between said intake arm and said outlet arm of said collector channel, wherein said curved subsection has an upstream end and a downstream end separated by a length, a convex inside surface, a concave inside surface, and a progressively narrowing critical dimension, said progressively narrowing critical dimension tapering from a maximum at said upstream end to a minimum at a neck or throat proximate to said downstream end; and
b) an elongate centrifugal impactor surface formed on said concave inside surface for impactingly capturing said aerosol particle, said elongate centrifugal impactor surface extending from said upstream end through said neck or throat of said collector channel, said captive aerosol particle constituting an aerosol sample.

2. The centrifugal particle trap of claim 1, wherein said elongate centrifugal impactor surface and progressively narrowing critical dimension are configured for varying a flow velocity and a thickness of a boundary layer of said flowing gas stream from said upstream end to said downstream end, said boundary layer having a maximum thickness at said upstream end and a minimum thickness at said neck or throat.

3. The centrifugal particle trap of claim 1, wherein said particle trap is operated in an incompressible flow regime.

4. The centrifugal particle trap of claim 1, wherein said particle trap is operated in a compressible subsonic flow regime.

5. The centrifugal particle trap of claim 1, wherein said particle trap is operated in an incompressible flow regime at said upstream end and a compressible flow regime at said neck or throat.

6. The centrifugal particle trap of claim 1, further comprising a diffuser, wherein said diffuser is fluidly connected to said throat.

7. The centrifugal particle trap of claim 6, wherein said particle trap is operated in a transonic flow regime.

8. The centrifugal particle trap of claim 1, wherein said inlet port is fluidly connected to an aerosol concentrator.

9. The centrifugal particle trap of claim 8, wherein said aerosol concentrator is a combination of a aerodynamic lens and a virtual impactor or an array of aerodynamic lenses and a virtual impactor.

10. The centrifugal particle trap of claim 1, wherein said particle trap comprises a compact body or block with closure means for said intake arm and said outlet arm, said closures for isolating said aerosol sample during transport and storage.

11. The centrifugal particle trap of claim 2, wherein said aerosol particle is a viable biological particle, and said thickness of said boundary layer is configured for enhancing the survivability of said viable biological particle on impaction.

12. An apparatus comprising a centrifugal particle trap of claim 1, wherein said centrifugal particle trap is operatively interfaced with a chiller for chilling or preserving said aerosol sample.

13. The apparatus of claim 12, wherein said chiller is operated to condense a water vapor on said elongate centrifugal impactor surface, said water vapor for preserving and storing a viable biological particle or a volatile explosives residue in said aerosol sample.

14. The apparatus of claim 12, wherein said chiller is operated to freeze a water layer on said elongate centrifugal impactor surface, said frozen water layer for preserving and storing a viable biological particle or a volatile explosives residue in said aerosol sample.

15. The centrifugal particle trap of claim 1, wherein said collector channel is modified with at least one waveguide, lens, or optical window for optically interfacing with a photometer.

16. An apparatus comprising a centrifugal particle trap of claim 1 and an on-board analysis module or an out-board analysis module, said analysis module for detecting in said aerosol sample a biological particle or constituent thereof, an aerosol particle or constituent thereof, or an explosives residue or constituent thereof.

17. The apparatus of claim 16, wherein said analysis module is configured for an analytical process selected from:
a) inducing fluorescence of specific constituents of the aerosol sample and detecting emitted fluorescent radiation, having the purpose of detecting, characterizing or quantitating those constituents of interest based on the spectrum of the emitted light;
b) measuring optical absorption of the aerosol sample at one or more wavelengths; having the purpose of detecting, characterizing or quantitating those constituents of interest based on the spectrum of the absorbed light;
c) measuring light scattered from the aerosol sample at one or more angles of scattering; having the purpose of detecting, characterizing or quantitating those constituents of interest based on the pattern of the scattered light;
d) subjecting the aerosol sample to a nucleic acid amplification and detecting an amplicon; having the purpose of detecting, characterizing or quantitating those constituents of interest based on the presence of a nucleic acid sequence;
e) subjecting the aerosol sample to an immunological assay; having the purpose of detecting, characterizing or quantitating those constituents of interest based on an antigen:antibody reaction;
f) subjecting the aerosol sample to at least one spectroscopic measurement technique selected from Raman spectroscopy (RS), surface-enhanced Raman spectroscopy (SERS), laser induced breakdown spectroscopy (LIBS), spark-induced breakdown spectroscopy (SIBS), surface plasmon resonance (SPR), or methods using fluorescence of particle constituents, having the purpose of detecting, characterizing or quantitating those constituents of interest;
g) subjecting the aerosol sample to electrometry, where electrodes are embedded along the elongated centrifugal impactor surface of the particle trap, having the purpose of detecting, characterizing or quantitating an electrical property of said aerosol sample; or
h) measuring a radioactive emission of said aerosol sample, having the purpose of detecting a radioactive constituent of said aerosol sample.

18. The apparatus of claim 16, wherein said analysis module is configured for optically scanning said elongated concave impactor surface.

19. The centrifugal particle trap of claim 1, wherein said collector channel is configured for receiving a first liquid thereinto, wherein said liquid, when contacted with said elongate impactor surface of said particle trap, is efficacious for suspending or dissolving said aerosol sample as a suspension or a solution, thereby forming a liquid sample.

20. The centrifugal particle trap of claim 19, further comprising an injection channel for injecting said first liquid into said collector channel.

21. The centrifugal particle trap of claim 19, further comprising a sampling channel for withdrawing said liquid sample from said collector channel.

22. The centrifugal particle trap of claim 19, wherein said first liquid is a wash reagent, a storage reagent, or a transport medium adapted for collecting a viable biological particle.

23. The centrifugal particle trap of claim 19, wherein said first liquid is a wash reagent, an analytical reagent, or a reactant selected for the detection in said liquid sample of a biological particle or constituent thereof, an aerosol particle or constituent thereof, or an explosives residue or constituent thereof.

24. The centrifugal particle trap of claim 19, wherein said centrifugal particle trap is integrated in the body of a microfluidic cartridge, said microfluidic cartridge with analytical works for conducting a nucleic acid assay or an immunoassay, and wherein said microfluidic cartridge is configured for fluidly conveying said liquid sample from said collector channel to said analytical works.

25. A process for operating a centrifugal particle trap of claim 1 to collect an aerosol particle as a liquid sample, which comprises:
a) directing a gas stream containing an aerosol particle into said collector channel, said collector channel with concavoconvexedly curved subsection disposed between said intake arm and said outlet arm, wherein said curved subsection has an upstream end and a downstream end separated by a length, a convex inside surface, a concave inside surface, and a progressively narrowing critical dimension, said progressively narrowing critical dimension tapering from a maximum at said upstream end to a minimum at a neck or throat proximate to said downstream end;
b) impactingly capturing said aerosol particle on said elongate centrifugal impactor surface within said collector channel, said elongate centrifugal impactor surface extending from said upstream end through said neck or throat of said collector channel, said captive aerosol particle constituting an aerosol sample;
c) suspending or dissolving said aerosol sample as a suspension or solution in a first reagent liquidly injected into said collector channel, thereby forming a liquid sample; and
d) optionally performing a treatment of said liquid sample;
e) optionally performing an analysis of said liquid sample; or
f) optionally conveying said liquid sample from said collector channel to a sampling port
g) optionally saving said liquid sample for later analysis.

26. The process of claim 25, wherein said step for optionally performing a treatment of said liquid sample is:
a) a step for chemical treatment by contacting said liquid sample with a second reagent having the purpose of chemically modifying a constituent of said liquid sample;
b) a step for a thermal treatment or an ultrasonic treatment having the purpose of resuspending, dissolving, reacting or lysing said aerosol sample in said liquid sample;
c) a step for radiological treatment with microwave or other radiation having the purpose of resuspending, dissolving, reacting or lysing said aerosol sample in said liquid sample; or,
d) a step for mechanical treatment having the purpose of mixing or moving said liquid sample in said collector channel.

27. The process of claim 25, wherein said step for performing an analysis of said liquid sample is:
a) a step for inducing fluorescence of specific constituents of the liquid sample and detecting emitted fluorescent radiation, having the purpose of detecting, characterizing or quantitating those constituents of interest based on the spectrum of the emitted light;
b) a step for measuring optical absorption of the liquid sample at one or more wavelengths; having the purpose of detecting, characterizing or quantitating those constituents of interest based on the spectrum of the absorbed light;
c) a step for measuring light scattered from the liquid sample at one or more angles of scattering; having the purpose of detecting, characterizing or quantitating those constituents of interest based on the pattern of the scattered light;
d) a step for subjecting the liquid sample to a nucleic acid amplification and detecting an amplicon; having the purpose of detecting, characterizing or quantitating those constituents of interest based on the presence of a nucleic acid sequence;
e) a step for subjecting the liquid sample to an immunological assay; having the purpose of detecting, characterizing or quantitating those constituents of interest based on an antigen:antibody reaction;
f) a step for subjecting the liquid sample to at least one spectroscopic measurement technique selected from Raman spectroscopy (RS), surface-enhanced Raman spectroscopy (SERS), laser induced breakdown spectroscopy (LIBS), spark-induced breakdown spectroscopy (SIBS), surface plasmon resonance (SPR), or methods using fluorescence of particle constituents, having the purpose of detecting, characterizing or quantitating those constituents of interest; or
g) a step for subjecting the liquid sample to electrometry, where electrodes are embedded in the collector duct of the particle trap, having the purpose of detecting, characterizing or quantitating an electrical property of said liquid sample; or
h) a step for measuring a radioactive emission of said liquid sample, having the purpose of detecting a radioactive constituent of said aerosol sample.
